(19) United States
(12) Patent Application Publication
(10) Pub. No.: US 2025/0338825 A1
(43) Pub. Date: Nov. 6, 2025

(54) Dog control snout muzzle and collar

(71) Applicant: TAE KYOU KIM, IRVINE, CA (US)

(72) Inventor: TAE KYOU KIM, IRVINE, CA (US)

(21) Appl. No.: 18/656,420

(22) Filed: May 6, 2024

(51) Int. Cl. A01K 25/00; A01K 27/00

(52) U.S. Cl. CPC A01K 25/00; A01K 27/001

(57) ABSTRACT

The invention relates to a dog's anti-biting controller, which comprises a snout muzzle (1) including air-inflating tubes (9a,9b) and a main collar (4) consisting of rechargeable battery with PCBA (5), an air-tube (10), air pump (6), and air-valve (8). The working mechanism of the invention is activated when the dog is out of control and attempts to bite humans. The main collar (4) and snout muzzle (1) can be activated with an order signal from a remote controller or connected line controller. This signal triggers the activation of the air pump (6) and air valve (8), which supply air via the air supply pipe located inside the collar connector (2) to the air tubes (9a, 9b,10) inflating them to force the closure of the dog's mouth and choke its neck.

### BACKGROUND OF THE INVENTION

Among various pets, dogs are one of the most favorite companions with humans and their population is growing faster with the help of economic development and increasing unmarried individuals. With these increasing number of dogs biting accidents also have been continuously increasing and some cases are critical for life threatening especially the cases involving large breeds dogs' biting such as American Pit Bulls and Rottweilers etc. Logically even some people raise dangerous breeds of dogs their owners should be able to control them forcefully in case of an emergency. However, the reality is not so ideal, as dogs can be fast runners and may aggressively rush towards a target within seconds, making them difficult to control. Furthermore, some seniors and ladies choose to raise big dogs to protect them from unexpected assaults, such as burglary. However, many of them may not have the ability to keep holding the dog leash to prevent the dog from jumping towards its target. In such cases, raising a large ferocious dog as a bodyguard or out of preference by someone physically weak can become a cause of fatal danger to others.

Accordingly, we need a safe device that can control dogs' attacks on people by force and immediately stop their assault. However, until now, there has not been any device to mitigate the risk of dog bites with mechanical assistance. Prior inventions have mainly focused on controlling a dog's barking behavior and stopping it using electrical shock.

U.S. Pat. No. 660,313B1 discloses the control of dogs using electric shock. However, this electric shock cannot be used once a dog has already bitten a human, as releasing electricity to the dog would also electrify the bitten human, posing a risk to both human and dog.

Patent EB1551220B1 demonstrates barking control using a spray supply function.

Patent EB11324200B2 showcases a device with vibration functionality and electric shock to discourage barking as a behavior training method.

U.S. Pat. No. 6,360,697B1 describes a pressure pulse transmitter designed to deter undesired behavior.

U.S. Pat. No. 20,050,277855A1 introduces a device that provides vibration to discourage dog barking.

All the aforementioned inventions, as well as others not mentioned, are primarily focused on dog behavior training and locating the dog. Therefore, the purpose of this invention is to develop a method for controlling and minimizing the damage caused by dog bites, which can be particularly formidable assaults, especially for vulnerable individuals such as women and children.

### BRIEF SUMMARY OF THE INVENTION

Physical restriction or physical force is necessary to control and restrain a dog's biting attack during dangerous moments. Accordingly, this invention focuses on these two aspects of forces. First, physical restriction can be achieved by placing a muzzle around dog's snout area, with an inflatable air tube located inside the muzzle. This inflated air tube restricts the dog's mouth opening, essential for biting. With this mechanism, dogs attempting to bite humans can be discouraged or prevented from biting. However, once a dog has already bitten a human, this mechanism is not appropriate to use because pressing down the snout with the inflated tube, especially when it is already biting a human, is not advisable. So, this muzzle inflating technique should be applied before dogs attempt to bite humans.

Secondly, physical force is another method to stop biting by compelling the dog to release its grip and open its mouth, allowing the bitten object to be freed. This physical force can be applied by inflating air tube located inside a dog collar. When the air tube inside the collar inflates, it tightens around the dog's neck, potentially suffocating it and reducing the air supply to the dog's brain, leading to a loss of biting intention due to oxygen deprivation. This technique, used in wrestling, is called a choke, which works by cutting off blood supply to the brain or by restricting airflow to the brain. This technique is also employed by professional dog trainers, who achieve a similar effect by pulling up on the leash until the collar tightens around the neck, potentially strangling it, using the dong's weight and gravity to assist. Currently, metal chain collars are available on the market. However, when weak or female owners face dangerous situations, it can be quite challenging for them to physically overpower a heavy dog and pull it up to the point of suffocation using only their physical strength until it stops biting. Therefore, to enable the control of large dogs using physical force, this invention proposes the inflation of the neck and mouth structures with the assistance of a motorized air pump, eliminating the need for human physical exertion. This automatic function allows individuals, particularly the weak or women, to easily control large dogs, similar to well-built men. Both functions can be integrated into a single device, and the snout muzzle inflating structure can be optional, depending on the buyer's preference or the consideration of the dog's snout length, especially for dogs with short snouts.

This invention is consisted of main collar designed to comfortably around a dog's neck, featuring an adjustable buckle holder and hook. The main ring-shaped collar contains an air tube that can be inflated according to the volume size of the air tube and the adjustable buckle length.

Additionally, inside the main frame collar are air supply pipes connected the air tube inside the main collar, which can also supply air to the air tube located inside the snout muzzle part.

The main collar exterior contains a rechargeable battery pack, which includes its controlling PCBA. This component also facilitates communication with a remote controller or wired leash. Additionally, the collar features an air pump equipped with a fan driven by a DC motor, an air supply solenoid valve part, and an outer cover. The main neck collar is connected to the snout muzzle part via connector.

The mechanism of operation of this invention is as follows: when an electrical signal is triggered via a remote controller or wired leash to stop a dog from biting, this signal activates the air valve. The slider inside the air valve moves to close the pathways for air drainage from the air tubes of the collars and snout muzzle to the air valve. Simultaneously, the air inlet, which allows airflow from the outer environment to the air valve, opens. Subsequently, air enters the air valve through the air inlet from the outer environment. This air is then supplied to the air tubes inside the collar and snout muzzle. With this mechanism, air from air tubes cannot be drained out. Instead, air from outer environment is supplied to the air pump via air valve. The pressurized air from the air pump is then supplied to the air tubes, ultimately inflating the tube as intended.

The mechanism for deflating the air from the air tubes is the reverse of the inflation process. When a deflating order is issued via remote controller or wired leash, this electric signal activates the air valve in deflation mode. The slider inside the air valve re-positions itself to block the air supply inlet to the air tubes. As a result, air from outer environment cannot flow into the air valve, and simultaneously, the air deflation pathways from the air tubes to the air valve are aligned to allow the air to drain out. At the same time, the air outlet to the outer environment opens, allowing the drained air from the air tubes to flow to the air pump via the air valve. Eventually, the air is expelled to the outer environment through the air outlet.

The air supply inflates each air tube until the inflation is suitable for the intended purpose, with the assistance of manually adjusting the buckle to the correct position and adjusting the size of the air tube. Additionally, an air pressure detector can be incorporated to monitor the pressure and tightness of the choke.

### BRIEF DESCRIPTION OF THE SEVERAL VIEWS OF THE DRAWING

FIG. 1 shows the complete embodiment of the invented device. The main collar (4) comprises the air tube (10), battery and PCBA (5), air pump (6), air valve (8) and outer cover (7). This main collar (4) is connected to the snout muzzle (1), which includes air tubes (9a,9b) adjustable buckle (3), and connector (2).

FIG. 2 shows a more detailed embodiment of the invented device, revealing the air supply pipe (22) located inside of the connector (2). And it also displays the air tubes (9a,9b) situated within the snout muzzle (1).

FIG. 3 shows the front view of the invented device, displaying the air tubes (9a, 9b) located inside of the snout muzzle (1).

FIG. 4 shows the front view of the invented device with the air tube (9a) inflated by the air supply inside the tube.

FIG. 5 displays the main collar (4) and its air tube (10) without the snout muzzle (1).

FIG. 6 illustrates the main collar (4) and its air tube (10) in the inflated state.

FIG. 7 shows the air valve (8) and its slider (8a). The slider (8a) is completely located inside the air valve (8).

FIG. 8. shows the section view of air valve (8) including the slider (8a). It also displays the locations of the air tubes and air pump. In this view, the position of the slider (8a) inside the air valve (8) is set for air supply to the air tubes.

FIG. 9 shows a section view of the air valve (8) including the slider (8a). It also displays the locations of the air tubes and air pump. In this view, the position of the slider (8a) is set for air drainage from the air tubes.

### DETAILED DESCRIPTION OF THE INVENTION

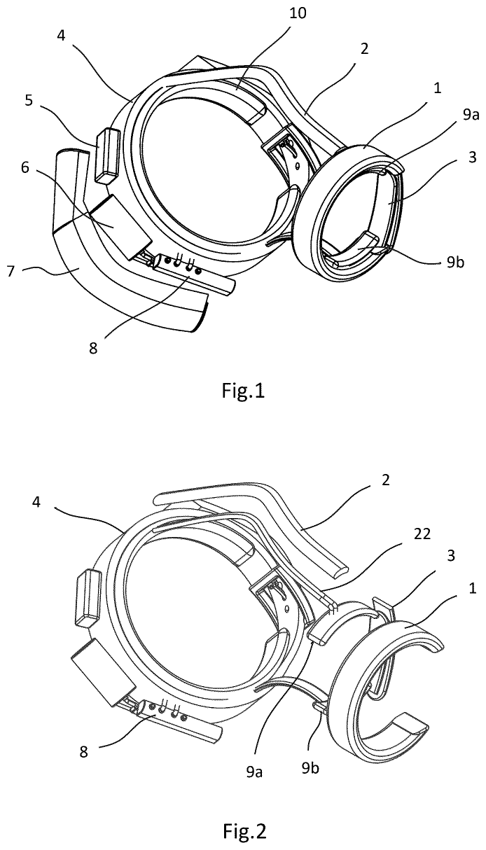

FIG. 1 and FIG. 2 depict the complete embodiment of the device. When an inflation or deflation order signal is transmitted via remote controller or wired leash, this signal is received by the PCBA, which includes a processing chip. Subsequently, the PCBA activates both the air pump (6) and the air supply valve (8), allowing air to flow into air valve (8) and air pump (6) from the outer environment. The compressed air generated by the air pump (6) is then delivered to the air supply pipes (22) and eventually reaches the air tubes (9a,9b). Similarly, using the same air inflation mechanism via the air valve (8) and air pump (6) air is supplied into air tube (10) in the main collar (4). The air tubes (9) can be inflated either individually or simultaneously. The air pump (6) consists of a rotating fan for air pressurization, a motor, an outlet hole, and an inlet hole.

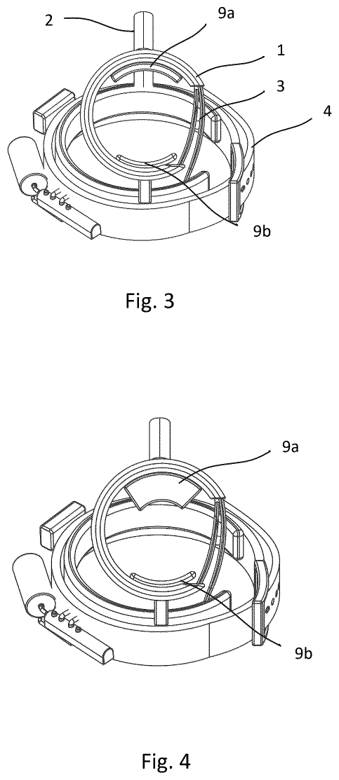

FIG. 3, FIG. 4 illustrate the difference between the inflated and deflated states of air tubes (9a,9b) from a front view. Once air is supplied to air tubes (9a, 9b), they inflate as depicted in FIG. 4 tightening and limiting the mouth's open space. In reverse, when a deflate signal is transmitted via remote controller or wired leash through the PCBA, which includes a processing chip, it activates the air pump (6) and air supply valve (8). The deflating mechanism of the air supply valve (8) forces the air inside air tubes (9a,9b) to be suctioned out to the outer environment, resulting in empty air tubes (9a,9b), as shown in FIG. 3.

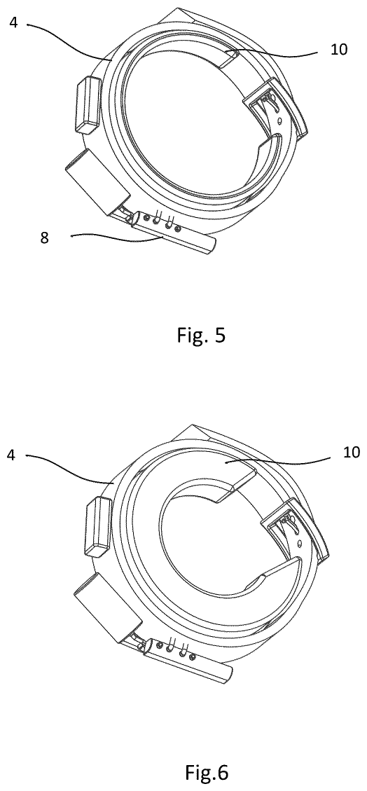

FIG. 5 displays the main neck collar (4) independently, indicating that this device can be manufactured separately from the snout muzzle (1). Some dogs have a shorter snout length, which may not be suitable for fitting with the snout muzzle part (1). However, the mechanism for inflating main collar (4) remains the same as that for inflating the snout muzzle (1). When a signal order is released via remote controller or wired leash to the PCBA, including process chip, air is supplied directly to air tube (10) from air valve (8) and air pump (6). This air inflates air tube (10), tightening around the dog's neck area as depicted in FIG. 6. Conversely, with an air deflate signal order, air valve (8) reverses its function to deflate air from air tube (10) to the outer environment immediately, as shown in FIG. 5.

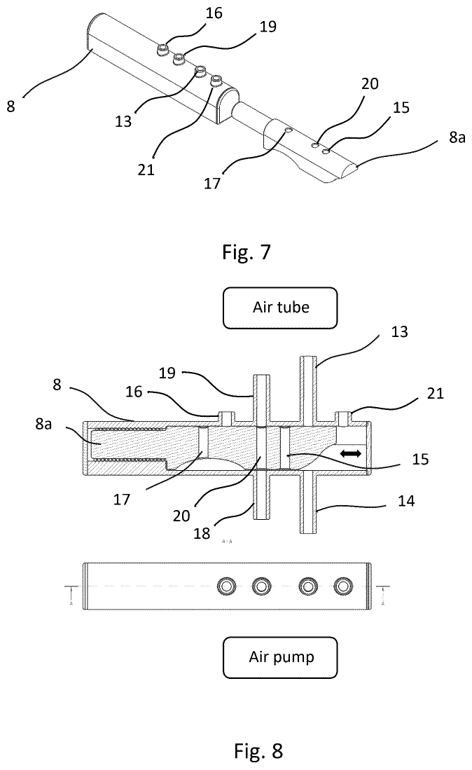

FIG. 7 shows the shape of the air valve (8) and its slider (8a). The slider (8a) is located inside the air valve (8) and moves linearly left and right through solenoid action. This linear movement and the featured shape of the slider (8a) can open and close the air flow corridor. The top side of the air valve (8a) has four air flow holes: two holes (16, 21) open to the outer environment to drain and supply air, and two holes connected to air pipes (19,13). The bottom of the air valve (8) has two holes connected to the air pump (6). The slider (8a) has three air flow holes (17, 20, 15) and a concave bottom shape to allow air flow.

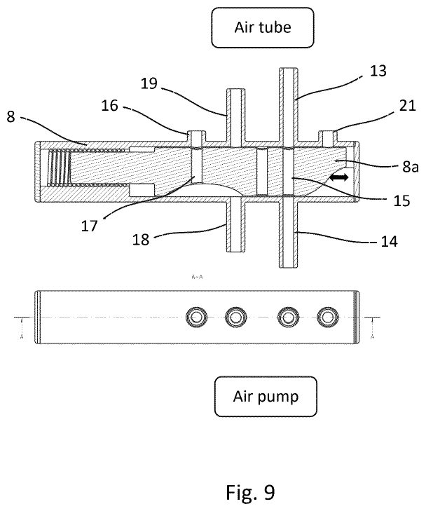

FIG. 8 and FIG. 9 show section views of the air valve (8). Air valve (8) consists of the air valve body and its slider, denoted as 8a. The air valve (8) has two inlets and two outlets on the top, as well as one inlet and one outlet underneath. The slider (8a) features three air flow holes and a concaved bottom shape to facilitate air flow. The air valve (8) is a solenoid valve that operates using electrical magnet force generated by copper coils. The electrical magnet force causes the slider (8a) to move linearly inside the air valve (8). The valve's structure, featuring different cylinder types of hole positions, allows air to flow to air tubes (9a,9b,10). By changing the slider's position, the valve can deflate air from air tubes (9a,9b,10). From the top side, the air supply pipe (19) is connected to an outlet of the air valve (8), while the opposite end of the air supply pipe (19) is connected to air tubes (9a,9b,10). Additionally, the air drain pipe (13) is linked to an inlet on the air pipe (8), and the opposite end of the air drain pipe (13) is connected to air tubes (9a,9b,10). On the bottom side of air valve (8), an inlet is connected to the air supply pipe (18), while an outlet is connected to the drain valve (14). Subsequently, both the air supply pipe (18) and the air drain pipe (14) are connected to the air pump (6).

In FIG. 8, the air inflation mechanism is depicted. When an air supply order is signaled by remote controller or wired leash via the battery and PCBA (5), it activates the air valve (8) and positions its slider (8a) as shown in FIG. 8. This positioning of slider (8a) allows air flow to air valve (8) from the outer environment via air inlet (21), while simultaneously blocking air drainage from the air tube 9a,9b and 10 via air drain pipe (13). As a result, air from the outer environment can enter air valve (8) via air inlet (21). This air flows into air pump (6), where it is pressurized via air drain pipe (14). The pressurized air inside air pump (6) is then directed to air supply pipe (18), and continues to flow into air hole (20) of slider (8a). From there, the air flows into air supply pipe (19) and finally reaches air tube 9a,9b and 10, which are connected to air supply pipe (19) and become inflated.

FIG. 9 illustrates the mechanism of air deflation from air tubes (9a,9b,10). With the positioning of slider (8a) as shown FIG. 9, air inlet (21) is blocked, preventing the supply of outer air from the environment via air inlet (21). Instead, with this slider (8a) positioned as shown in FIG. 9, the air drain pipe (13), air hole (15) of slider (8a) and air drain pipe (14) come into alignment. This positioning of slider (8a) disallows air input from the outer environment via air inlet (21), but it allows to drain out air from air tubes (9a,9b,10) via air drain pipe (13), air hole (15) and air drain pipe (14) to air pump (6). At the same time, with the slider (8a) positioned as shown in FIG. 9, it blocks the air supply to air pipe (19), which supplies air to air tube (9a,9b,10). Instead, this positioning aligns air outlet (16) and air hole (17) of slider (8a). The drained air from air tubes (9a,9b,10) passes through air drain pipe (13), air hole (15), and air supply pipe (14), reaching air pump (6). The air pump (6) then pushes out air to air supply pipe (18), and the air passes the open concaved-shape space under slider (8a), flowing into air hole (17) of slider (8a). Finally, the air flows out to the outer environment via air outlet (16). This process allows the air inside of air tubes (9a,9b,10) to be completely suctioned out to the outer environment. The drain mechanism is halted by detecting suction pressure with a detector, and as a safety measure, a stopping function based on a preset time interval can also be implemented.

1. A dog control snout muzzle and collar device comprise of an air tube inside of the main collar and air tubes inside of the snout muzzle.

2. The inflation of air tubes can be achieved through the inflation mode of the air valve and its slider's position with a concave shaped bottom part, allowing air flow into the air tubes via the air supply inlet and the air hole of slider of air valve.

3. The deflation of air from air tubes can be achieved through the deflation mode of the air valve and its slider position and during deflation mode, air is drained out from the air tubes via the air drain pipe, the air hole of slider and air drain pipe, and simultaneously, air supply to the air tubes is stopped.
